(19) United States
(12) Patent Application Publication
(10) Pub. No.: US 2023/0031152 A1
(43) Pub. Date: Feb. 2, 2023

(54) Knowledgebase Development Through Mining of Messaging Transactions

(71) Applicant: ServiceNow, Inc., Santa Clara, CA (US)

(72) Inventors: Vignesh Bhaskaran, Santa Clara, CA (US); Spandan Chakraborty, Santa Clara, CA (US); Soumil Mandal, Austin, TX (US); Milap Shah, Santa Clara, CA (US); Amjad Shaikh, Santa Clara, CA (US)

(21) Appl. No.: 17/387,459

(22) Filed: Jul. 28, 2021

(51) Int. Cl. G06F 16/2457; G06F 16/11; G06F 16/2458; G06N 20/00

(52) U.S. Cl. CPC G06F 16/24578; G06F 16/113; G06F 16/2465; G06N 20/00

(57) ABSTRACT

A system includes persistent storage containing an archive, a first interface to a messaging system that includes a plurality of channels, a second interface to a machine learning system that includes a query detection model and a reply detection model, and a processor configured to perform operations including receiving, from the message system, messages that appeared in a particular channel of the plurality of channels. The operations also include providing, to the machine learning system, the messages, where reception of the messages causes the query detection model to detect a query within the messages and the reply detection model to detect, within the messages, replies to the query. The operations further include receiving, from the machine learning system, the query and the replies, and storing, in the archive, the query, the replies, and an indication that the replies relate to the query.

### BACKGROUND

Users associated with a computer network may exchange information with one another using various messaging systems. At least some of this information might not be stored in formal information repositories associated with the computer network, and thus might not be obtainable without contacting the relevant user and/or manually parsing a prior conversation involving the relevant user. However, repeated contacts with the relevant user and/or manual parsing of the prior conversation may be inefficient and/or impractical, and may thus inhibit the flow of information through the computer network. For example, the relevant user might be temporarily unavailable to reply to queries, and obtaining the information may thus involve an undesirable time delay. Additionally, prior conversations may be periodically deleted, and may thus be unavailable for manual review, or the amount of prior conversations may be sufficiently large to make even search-assisted manual review impractical.

### SUMMARY

Users associated with a computer network may utilize a messaging system to exchange information with one another. This exchange of information may take the form of various conversations occurring on different channels of the messaging system. In some cases, a message that forms part of the conversation may include a query, and a subsequent message in the conversation may include a reply to the query. The same or similar query may be asked at a later time by another user associated with the computer network. Thus, the reply to the query may be useful outside of the context of the original conversation. However, in some cases, the messaging system may be configured to delete the original conversation after the conclusion thereof and/or after a predetermined time. Thus, the query and reply might be discarded, and the other user may again post the same or similar query in order to obtain a reply thereto.

Accordingly, it is desirable to archive at least some of the information exchanged by way of the messaging system. However, since conversations carried out by way of the messaging system are generally unstructured and may include messages that do not include useful information, the plurality of messages that make up a conversation may need to be processed to extract useful information and discard textual noise. Specifically, the plurality of messages may be processed by a machine learning system that includes a plurality of natural language processing (NLP) models that are configured to (i) detect a query, (ii) detect one or more replies to the query, and (iii) rank the one or more replies according to relevance and/or correctness. The machine learning system may search the plurality of messages, as well as other documents available within the computer network, for replies to the query. The replies may be ranked according to a relevance, which may be quantified based on user feedback provided in response to the replies as part of the plurality of messages.

The replies identified by the machine learning system might not always be correct. For example, a user may provide a reply that is responsive to the query but is incorrect, or the machine learning system may identify a reply that is not responsive to the query. Accordingly, at least some of the replies generated by the machine learning system may be provided to a human arbiter for verification and/or correction. The human arbiter may be selected, for example, based on a topic of the query. The human arbiter may review the machine-generated replies and, based thereon, provide a canonical reply by selecting one of the machine-generated replies, revising one of the machine-generated replies, or providing an entirely new reply. The query, the machine-generated replies, and/or the canonical reply may be stored in an archive to be used in replying to future queries.

Specifically, another user may post a second query using the messaging system. This second query may be detected, and a previously-answered query corresponding thereto may be identified by searching the archive. The corresponding previously-answered query may be selected based on a textual similarity metric between the second query and the previously-answered query. The second query may thus be automatically replied to using the canonical reply and/or one or more of the machine-generated replies of the previously-answered query. For example, the canonical reply and/or the one or more of the machine-generated replies may be posted on the messaging system as a response to the second query (e.g., within 30 seconds of the second query being posted). Accordingly, information that might otherwise be discarded may instead be organized and archived, and thus provided on-demand as this information is requested by other users. In particular, the messaging system, the computer network, and the machine learning system may operate to respond to user queries automatically, without users needing to explicitly query the archive and/or the machine learning system.

Accordingly, a first example embodiment may involve a system that includes persistent storage containing an archive and a first interface to a messaging system. The messaging system may include a plurality of channels. Each of the plurality of channels may respectively facilitate one or more conversations. The system may also include a second interface to a machine learning system. The machine learning system may include a query detection model and a reply detection model. The system may further include one or more processors configured to perform operations. The operations may include receiving, from the message system and by way of the first interface, a set of messages that includes one or more messages that appeared in a particular channel of the plurality of channels. The operations may also include providing, to the machine learning system and by way of the second interface, the set of messages. Reception of the set of messages may cause (i) the query detection model to detect a query within the set of messages and (ii) the reply detection model to detect, within the set of messages, one or more replies to the query. The operations may additionally include receiving, from the machine learning system and by way of the second interface, the query and the one or more replies. The operations may further include storing, in the archive, the query, the one or more replies, and an indication that the one or more replies relate to the query.

A second example embodiment may involve receiving, from a message system that includes a plurality of channels and by way of a first interface to the message system, a set of messages including one or more messages that appeared in a particular channel of the plurality of channels. Each of the plurality of channels may respectively facilitate one or more conversations. The second example embodiment may also involve providing, to a machine learning system that includes a query detection model and a reply detection model, the set of messages by way of a second interface to the machine learning system. Reception of the set of messages may cause (i) the query detection model to detect a query within the set of messages and (ii) the reply detection model to detect, within the set of messages, one or more replies to the query. The second example embodiment may additionally involve receiving, from the machine learning system and by way of the second interface, the query and the one or more replies. The second example embodiment may further involve storing, in an archive contained in persistent storage, the query, the one or more replies, and an indication that the one or more replies relate to the query.

In a third example embodiment, an article of manufacture may include a non-transitory computer-readable medium, having stored thereon program instructions that, upon execution by a computing system, cause the computing system to perform operations in accordance with the first example embodiment and/or the second example embodiment.

In a fourth example embodiment, a computing system may include at least one processor, as well as memory and program instructions. The program instructions may be stored in the memory, and upon execution by the at least one processor, cause the computing system to perform operations in accordance with the first example embodiment and/or the second example embodiment.

In a fifth example embodiment, a system may include various means for carrying out each of the operations of the first example embodiment and/or the second example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIG. 6 depicts interfaces between a messaging system, a remote network management platform, and a machine learning system, in accordance with example embodiments.

FIG. 7 depicts aspects of a machine learning system, in accordance with example embodiments.

FIGS. 8A, 8B, and 8C depict a message flow diagram, in accordance with example embodiments.

FIG. 9 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. INTRODUCTION

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HTML and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. EXAMPLE COMPUTING DEVICES AND CLOUD-BASED COMPUTING ENVIRONMENTS

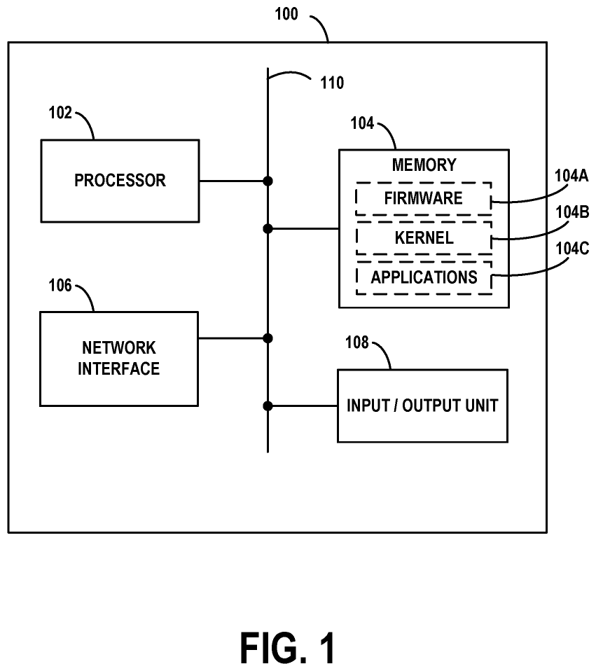

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling, and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

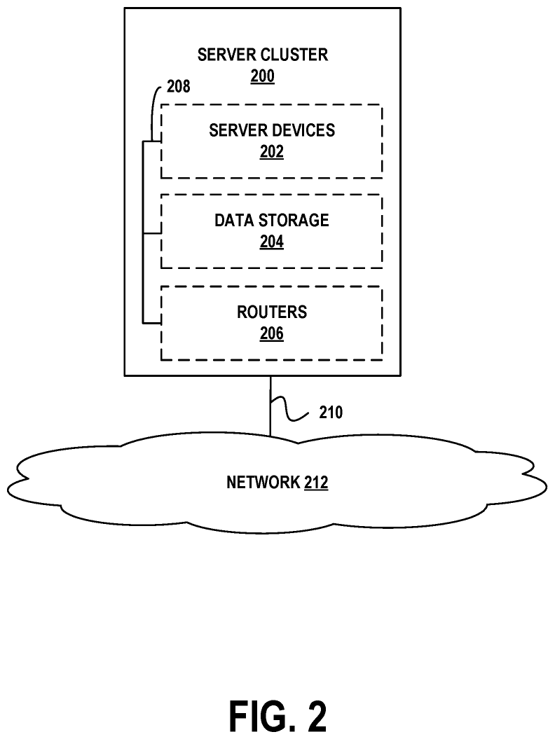

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. EXAMPLE REMOTE NETWORK MANAGEMENT ARCHITECTURE

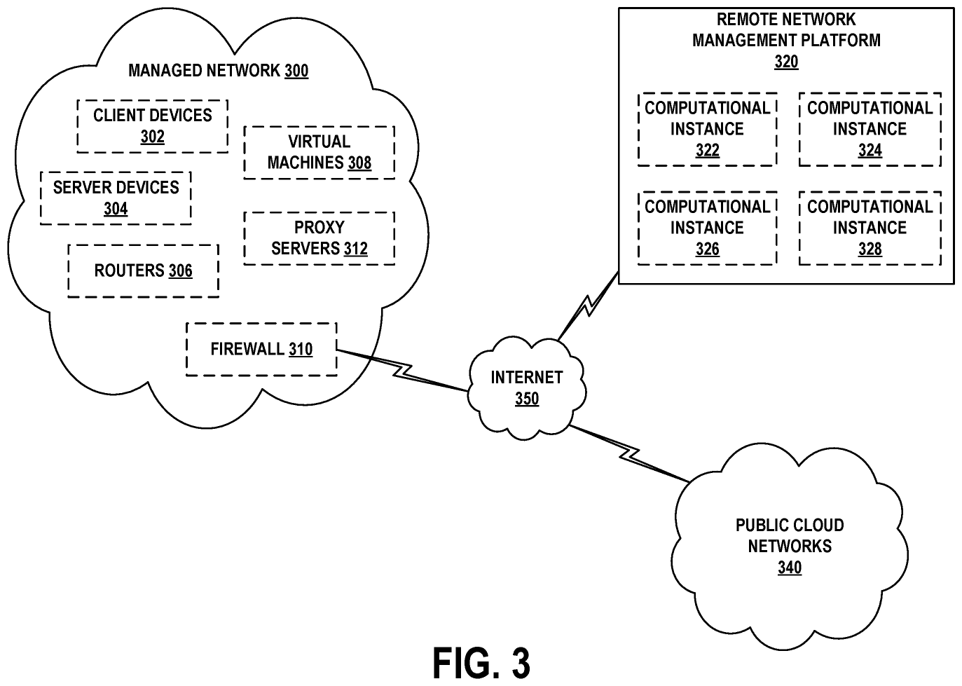

FIG. 3 depicts a remote network management architecture, in accordance with example embodiments. This architecture includes three main components—managed network 300, remote network management platform 320, and public cloud networks 340—all connected by way of Internet 350.

A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of public cloud networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include AMAZON WEB SERVICES® and MICROSOFT® AZURE®. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

D. Communication Support and Other Operations

Internet 350 may represent a portion of the global Internet. However, Internet 350 may alternatively represent a different type of network, such as a private wide-area or local-area packet-switched network.

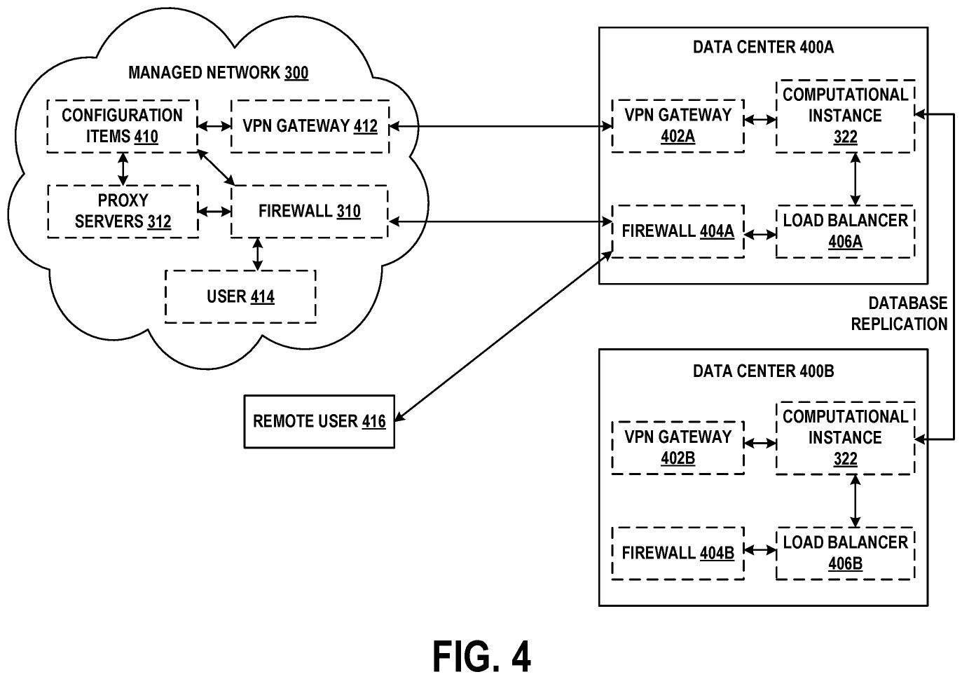

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### IV. EXAMPLE DEVICE, APPLICATION, AND SERVICE DISCOVERY

In order for remote network management platform 320 to administer the devices, applications, and services of managed network 300, remote network management platform 320 may first determine what devices are present in managed network 300, the configurations and operational statuses of these devices, and the applications and services provided by the devices, as well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purposes of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

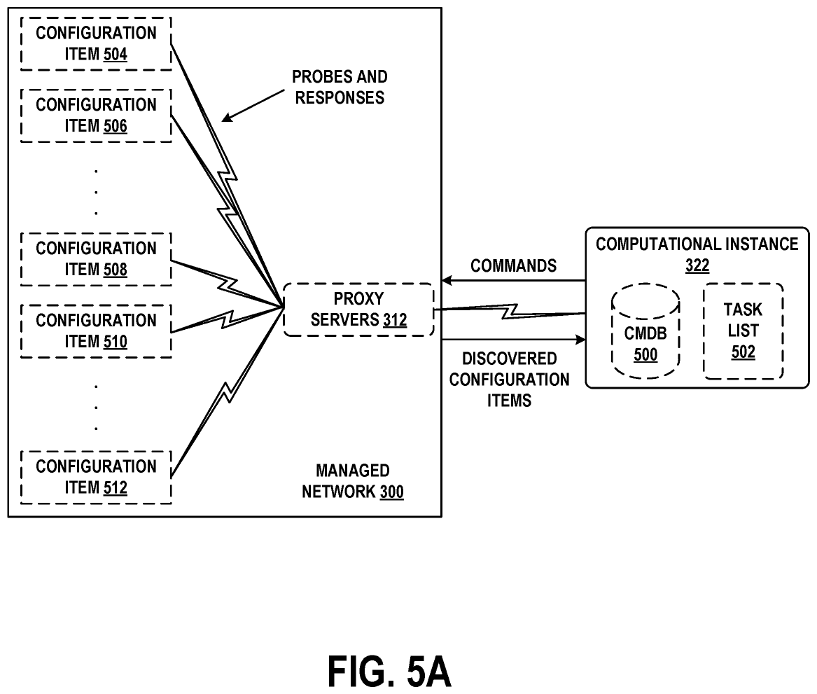

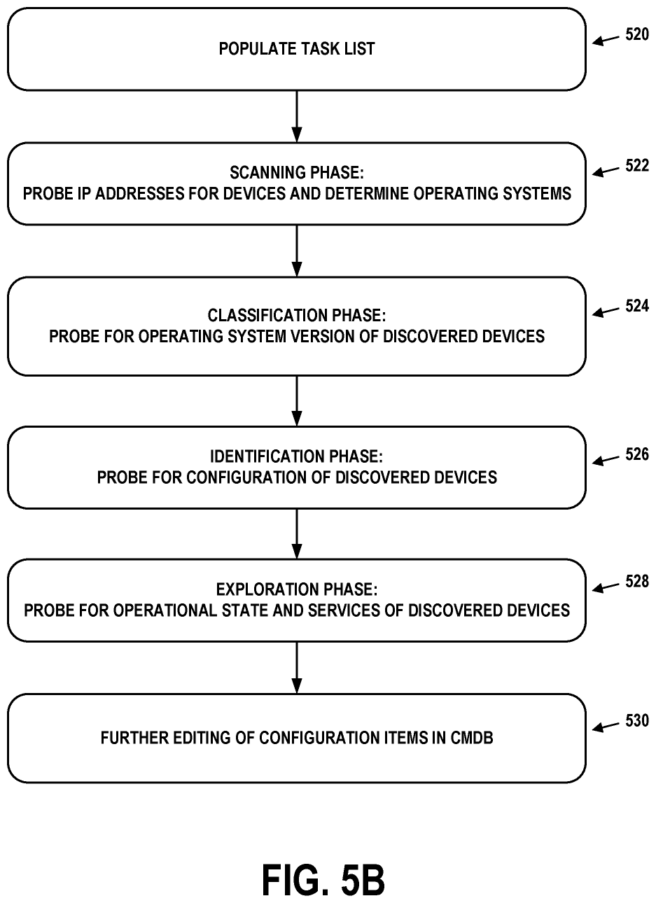

FIG. 5A provides a logical depiction of how configuration items can be discovered, as well as how information related to discovered configuration items can be stored. For sake of simplicity, remote network management platform 320, public cloud networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration, and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For example, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items may be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are examples. Discovery may be a highly configurable procedure that can have more or fewer phases, and the operations of each phase may vary. In some cases, one or more phases may be customized, or may otherwise deviate from the exemplary descriptions above.

In this manner, a remote network management platform may discover and inventory the hardware, software, and services deployed on and provided by the managed network. As noted above, this data may be stored in a CMDB of the associated computational instance as configuration items. For example, individual hardware components (e.g., computing devices, virtual servers, databases, routers, etc.) may be represented as hardware configuration items, while the applications installed and/or executing thereon may be represented as software configuration items.

The relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

The relationship between a service and one or more software configuration items may also take various forms. As an example, a web service may include a web server software configuration item and a database application software configuration item, each installed on different hardware configuration items. The web service may have a “depends on” relationship with both of these software configuration items, while the software configuration items have a “used by” reciprocal relationship with the web service. Services might not be able to be fully determined by discovery procedures, and instead may rely on service mapping (e.g., probing configuration files and/or carrying out network traffic analysis to determine service level relationships between configuration items) and possibly some extent of manual configuration.

Regardless of how relationship information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

### V. EXAMPLE SYSTEM ARCHITECTURE

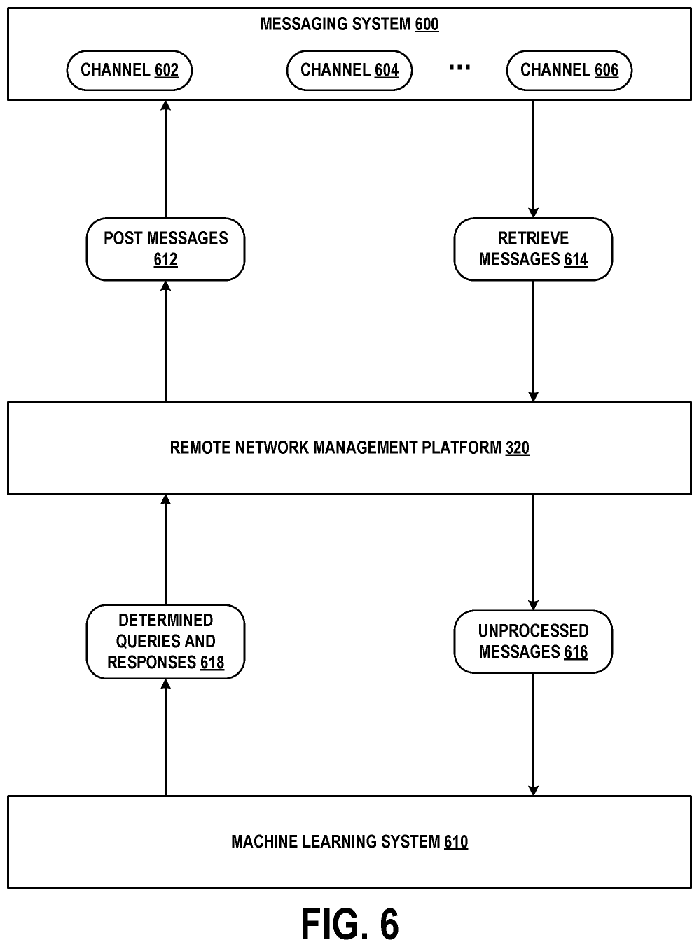

FIG. 6 illustrates an example architecture that includes remote network management platform 320, messaging system 600, and machine learning system 610. Messaging system 600 may be used by human users associated with remote network management platform 320 to communicate with one another. As part of a given conversation on messaging system 600, two or more users may exchange information that may also be useful to one or more other users that are not part of the given conversation. However, the given conversation might not be readily available and/or accessible to the one or more other users.

For example, messaging system 600 may be configured to delete the given conversation or portions thereof at a predetermined time after the given conversation or portions thereof occur. Thus, the conversation might be deleted before the one or more other users seek the information. Additionally, the number of messages exchanged via messaging system 600 may be very large, and thus difficult and/or impracticable to manually parse or search for the information. Thus, even if the conversation has not yet been deleted, the one or more other users may be unable to readily identify the information.

Accordingly, the one or more other users may initiate additional conversations intended to obtain the information, thereby unnecessarily expending resources on a task that has previously been completed. Accordingly, remote network management platform 320 (e.g., computational instance 322 thereof) and machine learning system 610 may be used to facilitate the curation of information exchanged by way of messaging system 600.

In particular, messaging system 600 may include a plurality of channels, including channel 602 and channel 604 through channel 606 (i.e., channels 602-606). Each of channels 602-606 may be associated with a corresponding topic or subject intended to be discussed thereon. Additionally, each of channels 602-606 may include a plurality of messages associated therewith. These messages may be organized into groups or subsets, which may be referred to as threads. Messaging system 600 may represent, for example, SLACK®, GOOGLE CHAT®, CHANTY®, and/or MICROSOFT TEAMS®, among other possibilities. Messaging system 600 may be hosted on a first set of one or more servers that are located outside of remote network management platform 320. Accordingly, messaging system 600 may alternatively be referred to as a third-party messaging system 600.

Users associated with remote network management platform 320 may post messages to messaging system 600, as indicated by block 612. In some cases, these messages might originate from computing devices that are logically associated with remote network management platform 320, but that are not physically disposed within remote network management platform 320. Prior to deletion of these messages by messaging system 600, remote network management platform 320 may be configured to retrieve and store at least a subset of the messages exchanged on messaging system 600, as indicated by block 614. The message exchange denoted by blocks 612 and/or 614 may be facilitated and/or performed by way of a first interface to messaging system 600. For example, the first interface may be an application programming interface (API) that is available to computing resources (e.g., computational instance 322) within remote network management platform 320 and which may be used by these computing resources to obtain data and/or signals from messaging system 600.

After obtaining the messages at block 614, remote network management platform 320 may be configured to utilize machine learning system 610 to extract and/or organize the information present in the retrieved messages, as indicated by block 616. Machine learning system 610 may be configured to determine, based on the messages and/or other documents, queries presented within the messages and one or more responses to each of these queries, as indicated by block 618. The queries and responses of block 618 may be stored in an archive by remote network management platform 320 and used to reply to future queries from other users.

Machine learning system 610 may represent, for example, MICROSOFT® AZURE®, IBM CLOUD®, GOOGLE CLOUD PLATFORM™, AMAZON WEB SERVICES®, and/or TENSORFLOW®, among other possibilities. Machine learning system 610 may be hosted on a second set of one or more servers that are located outside of remote network management platform 320. Accordingly, machine learning system 610 may alternatively be referred to as a third-party machine learning system 610. The message exchanges denoted by blocks 616 and/or 618 may be facilitated and/or performed by way of a second interface to machine learning system 610. For example, the second interface may be an API that is available to computing resources within remote network management platform 320 and which may be used by these computing resources to control operations of machine learning system 610.

In some implementations, remote network management platform 320 may operate on behalf of managed network 300, or may be entirely replaced by computing resources of managed network 300. Accordingly, in the context of FIGS. 6, 7, 8A, 8B, and 8C, the operations performed by remote network management platform 320 may, in some implementations, instead be performed on behalf of and/or by managed network 300. Further, in some implementations, aspects of messaging system 600 and/or machine learning system 610 may form part of remote network management platform 320. For example, the computing resources that provide messaging system 600 and/or machine learning system 610 may instead be logically and/or physically disposed within remote network management platform 320.

### VI. EXAMPLE MACHINE LEARNING SYSTEM

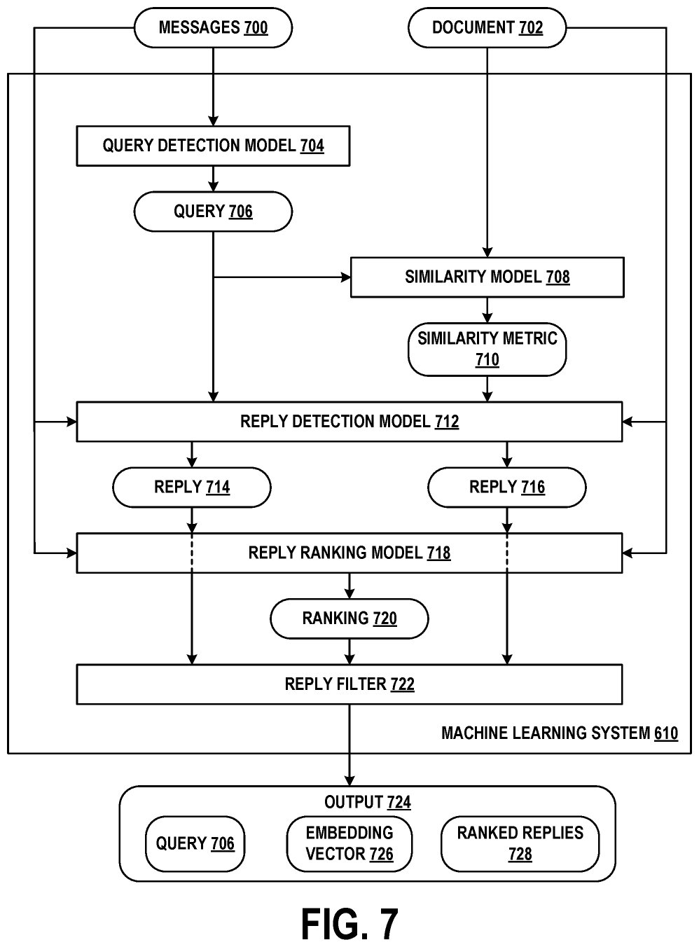

FIG. 7 illustrates aspects of machine learning system 610. Specifically, machine learning system 610 may include query detection model 704, similarity model 708, reply detection model 712, reply ranking model 718, and reply filter 722, among other components. Machine learning system 610 may be configured to generate output 724 based on messages 700 and, possibly, based on document 702. Components of machine learning system 610 may be implemented as hardware, software, or a combination thereof.

Messages 700 may represent a set of one or more messages that appeared on a particular channel of channels 602-606 of messaging system 600, have been retrieved by remote network management platform 320 at block 614, and have been provided to machine learning system 610 at block 616. Messages 700 may include a query (i.e., a question) asked by a first user, a reply (i.e., an answer) provided in response to the query by a second user, and/or user feedback provided by, for example, the first user in response to the reply. The user feedback may express, for example, a perceived extent of correctness of the reply.

Machine learning system 610 may be configured to facilitate the curation and archival of information exchanged by way of messaging system 600 by organizing this information into query-response pairs that may be used to respond to future queries posted on messaging system 600. Accordingly, query detection model 704 may be configured to detect query 706 within messages 700. As discussed above, query 706 may have been posed by the first user as part of a conversation represented by messages 700. Query detection model 704 may include, for example, an artificial neural network model that has been trained to detect queries within textual data using a plurality of text samples labeled as either containing a query or not containing a query.

Accordingly, query detection model 704 may be configured to process messages 700 and differentiate between (i) character strings that contain and/or represent a query from (ii) character strings that do not contain and/or do not represent a query. For example, each respective message of messages 700 may be individually provided as input to query detection model 704 and, based thereon, query detection model 704 may be configured to generate a corresponding query likelihood value indicative of a likelihood that the respective message contains a query. When the corresponding query likelihood value exceeds a threshold query likelihood value, the respective message may be determined to be a query, and may be provided as input to other components of machine learning system 610.

Reply detection model 712 may be configured to determine reply 714 based on query 706 and messages 700. Specifically, reply detection model 712 may be configured to process messages 700 and identify one or more character strings that constitute replies to query 706. Reply detection model 712 may include an embedding layer configured to generate (i), for each respective character string of one or more character strings in a respective message of messages 700, a corresponding embedding vector that represents the respective character string and (ii), for each respective character string of one or more character strings in query 706, a corresponding embedding vector that represents the respective character string.

For example, the respective character string may be a word, and the corresponding embedding vector may thus be a word vector. Word vectors may be determined for words present in a corpus of textual records such that words having similar meanings (or semantic content) are associated with word vectors that are near each other within a semantically encoded vector space. Such vectors may have tens, hundreds, or more elements and thus may be an n-space where n is a number of dimensions. These word vectors may allow the underlying meaning of words to be compared or otherwise operated on by a computing device (e.g., by determining a distance, a cosine similarity, or some other measure of similarity between the word vectors).

Despite the usefulness of word vectors, the complete semantic meaning of a multi-word character string representing, for example, an entire query might not always be captured from the individual word vectors of the query (e.g., by applying vector algebra). Word vectors can represent the semantic content of individual words and may be trained using short context windows. Thus, the semantic content of word order and any information outside the short context window may be lost when operating based only on word vectors.

Thus, an artificial neural network or other machine learning models may be trained using a large number of paragraphs (i.e., multi-word character strings) in a corpus to determine the contextual meaning of entire paragraphs and/or other multi-word text samples, as well as to determine the meaning of the individual words that make up the paragraphs in the corpus. For example, for each paragraph in a corpus, an ANN can be trained with fixed-length contexts generated from moving a sliding window over the paragraph. Thus, a given paragraph vector may be shared across all training contexts created from its source paragraph, but not across training contexts created from other paragraphs.

Accordingly, reply detection model 712 may also include an encoding layer (i.e., an encoder) configured to jointly process multiple words of the respective message and/or query 706 to generate hidden states that represent the overall meaning of groupings of multiple words. Reply detection model 712 may additionally include an attention layer configured to process the hidden states to determine attention scores between one or more words of query 706 and one or more words of the respective message of messages 700. The attention scores may be computed in various ways, some of which are discussed in a paper titled “Attention in Natural Language Processing,” authored by Galassi et al., and published as arXiv:1902.02181. Reply detection model 712 may further include an output layer (e.g., a softmax function) configured to process the attention scores to determine a start position and an end position of reply 714 within the respective message. Specifically, each respective start position of a plurality of candidate start positions, as well as each respective end position of a plurality of candidate end positions, may be associated with a corresponding confidence value. Accordingly, reply 714 may be determined by selecting a start position and an end position combination that maximizes a product of the corresponding confidence values, where the start position precedes the end position.

In one example, reply detection model 712 may be structured as a bidirectional encoder representations from transformers (BERT) model and/or a variation thereof. The BERT model may be pre-trained using a corpus of textual data obtained from various sources and representing various topics. Reply detection model 712, including the BERT model, may subsequently be fine-tuned using query-and-response pairs generated by remote network management platform 320, and may thus be configured to more accurately identify responses to queries generated by users in remote network management platform 320.

In addition to searching message 700 (from which query 706 originated) for replies to query 706, reply detection model 712 may also be configured to search for replies to query 706 in other documents associated with remote network management platform 320. For example, reply detection model may be configured to determine reply 716 based on query 706 and document 702. Document 702 may represent another set of messages obtained from messaging system 600, informational articles generated, maintained, and/or stored by remote network management platform 320, and/or incident descriptions and resolutions generated by users associated with remote network management platform 320, among other possible textual data sources expected to contain relevant information.

Since remote network management platform 320 may be associated with a large number of documents, many of which may be irrelevant to query 706, selection of documents that are relevant to query 706 may be facilitated by similarity model 708. Similarity model 708 may be configured to generate similarity metric 710 based on query 706 and document 702. Similarity metric 710 may represent an extent of textual similarity between query 706 and document 702, and may thus be indicative of a likelihood that document 702 contains at least one reply to query 706. In one example, similarity metric 710 may represent a Jaccard similarity between query 706 and document 702. In another example, similarity metric 710 may represent a distance between a first embedding vector that represents query 706 and a second embedding vector that represents document 702, each of which may be computed using, for example, the embedding layer of reply detection model 712 or a commensurate layer of similarity model 708. Selection of document 702 may be facilitated by a similarity-based search algorithm such as, for example, Facebook AI Similarity Search (FATS S).

Reply detection model 712 may be configured to process documents associated with a similarity metric value that exceeds a threshold similarity value. Accordingly, reply detection model 712 may be configured to look for replies in documents that are likely to contain replies to query 706, and avoid processing documents that are unlikely to contain replies to query 706. Document 702 may be considered an example of a document that is likely to contain a reply to query 706 due to similarity metric 710 exceeding the threshold similarity value. Accordingly, reply detection model 712 may be configured to identify reply 716 within document 702. Similarly, additional replies may be identified within messages 700, document 702, and/or other documents. Similarity model 708 might not determine the similarity between query 706 and messages 700 because messages 700 may automatically be considered a likely source of replies due to the fact that query 706 originated from messages 700.

Although replies 714 and 716 (and any other replies generated by model 712 to query 706) may be responsive to query 706, these replies may vary in quality, detail, accuracy, age, and/or correctness, among other factors. Accordingly, reply ranking model 718 may be configured to determine ranking 720 of the replies generated by reply detection model 712 for query 706. Specifically, reply ranking model 718 may be configured to generate ranking 720 based on one or more attributes associated with each reply (e.g., 714 and 716) generated by reply detection model 712 for query 706. For example, the attributes associated with reply 714 may include a confidence value generated by reply detection model 712 in connection with reply 714, an age of reply 714, and/or a quality of user feedback provided within messages 700 in response to reply 714, among other possible attributes. Other possible attributes may include a length of reply 714, a number of grammatical errors in reply 714, a similarity between reply 714 and other replies (e.g., reply 716) to query 706.

The confidence value associated with reply 714 may indicate a likelihood that reply 714 is a correct response to query 706. The age of reply 714 may indicate an amount of time that has elapsed since reply 714 was provided as part of messages 700, with older replies being more likely to contain outdated information.

The quality of user feedback may indicate, for example, a degree to which the first user that posed query 706 within message 700 is satisfied with reply 714 provided within messages 700 by the second user. To that end, reply ranking model 718 may be configured to perform sentiment analysis of at least the user feedback for reply 714 to determine a sentiment score associated with reply 714. The user feedback may include one or more of a plurality of possible data types and/or data formats, including text (e.g., “Thanks! My question has been answered.” may indicate that reply 714 is correct), image data (e.g., a graphics interchange format (GIF) image containing an animation of a person clapping may indicate that reply 714 is correct), and/or pictorial symbols (e.g., a “thumbs-down” emoji may indicate that reply 714 is incorrect). In some implementations, reply ranking model 718 may be configured to perform sentiment analysis based on one or more of these data types and/or formats, and may thus facilitate ranking using multi-format user feedback.

In one example, reply ranking model 718 may implement the function Sᵢ=αCᵢ+β(1/Aᵢ)+γFᵢ+δOᵢ, where Sᵢ indicates a ranking score associated with the ith reply, Cᵢ represents a confidence value generated for the ith reply by reply detection model 712, Aᵢ represents an age of the ith reply, Fᵢ represents the sentiment score generated for the ith reply, Oᵢ represents one or more other potential attributes, and α, β, γ, and δ represent adjustable weights that may be used to control a relative importance of different attributes. Thus, the replies generated by reply detection model 712 may be arranged in order of decreasing ranking scores, with the reply associated with the highest ranking score being ranked first in ranking 720.

Reply filter 722 may be configured to generate output 724 based on ranking 720 and the replies generated by reply detection model 712. Output 724 may include query 706, embedding vector 726 corresponding to query 706, and ranked replies 728. Embedding vector 726 may be based on, for example, the embedding vectors of individual words that make up query 706 or may be a paragraph vector corresponding to query 706, among other possibilities. For example, embedding vector 726 may be a weighted combination and/or a concatenation of the individual word embedding vectors generated by reply detection model 712 for query 706. Additionally or alternatively, embedding vector 726 may be based on a latent space representation of query 706 as generated by one or more other component of machine learning system 610.

Ranked replies 728 may include up to a predetermined number of highest-ranked replies from ranking 720. In some implementations, each of ranked replies 728 may be selected based on being associated with a ranking score that exceeds a threshold ranking score. Output 724 may form part of the queries and responses indicated by block 618, and may thus be stored in the archive by remote network management platform 320 to be used in replying to future queries.

### VII. EXAMPLE MESSAGE FLOW DIAGRAM

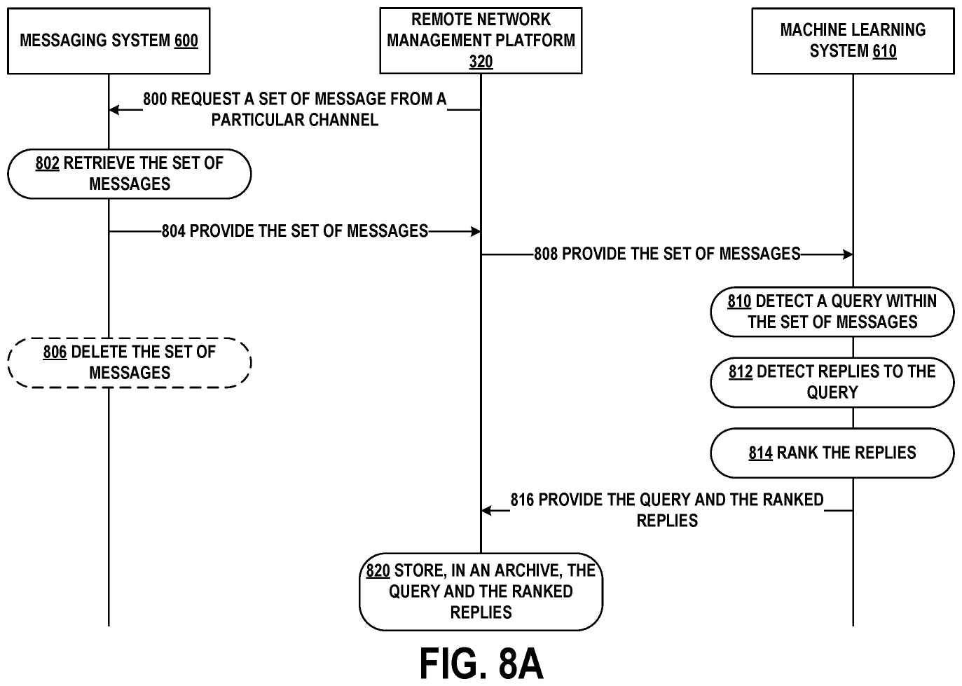

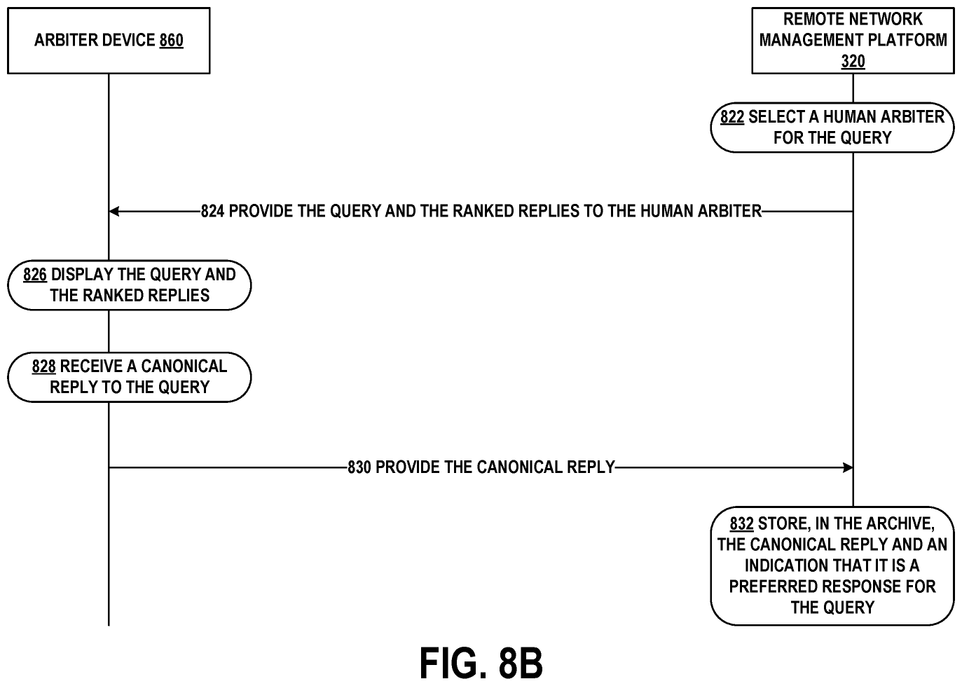

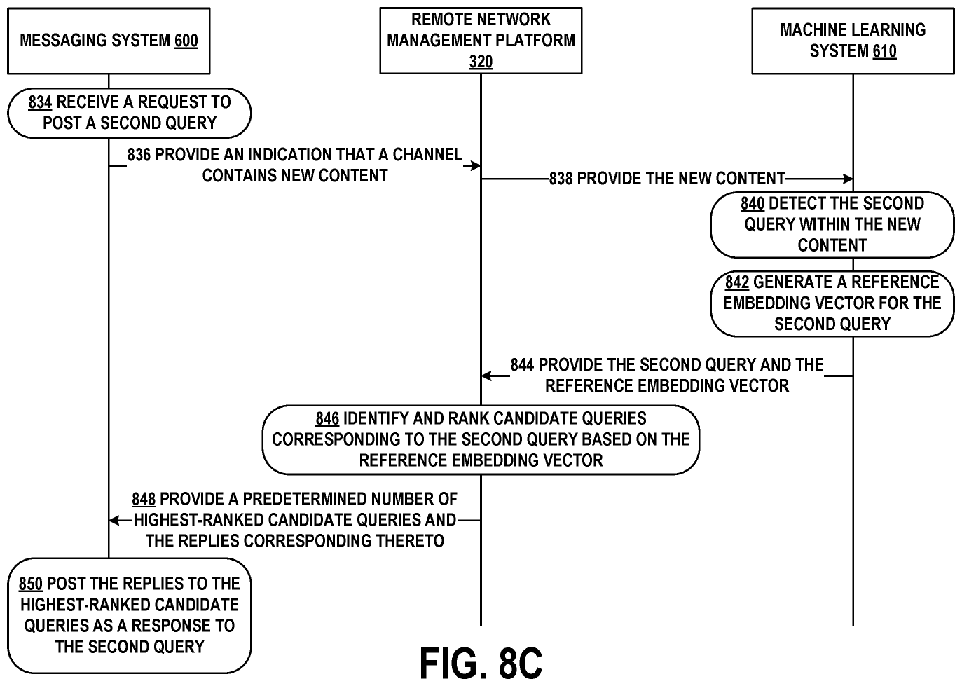

FIGS. 8A, 8B, 8C illustrate example operations carried out by remote network management platform 320, messaging system 600, and machine learning system 610 to automatically provide replies to queries posed by human users associated with remote network management platform 320. Specifically, FIG. 8A illustrates operations involved in generating an archive of queries and replies, FIG. 8B illustrates operations involved in verifying the replies in the archive with the assistance of a human arbiter, and FIG. 8C illustrates operations involved in using the archive to reply to queries posed by users.

Turning to FIG. 8A, remote network management platform 320 may be configured to transmit, to messaging system 600, a request for a set of messages from a particular channel (e.g., channel 604), as indicated by arrow 800. This request may specify a time range for the requested set of messages. Specification of the time range may allow remote network management platform 320 to avoid obtaining messages that have previously been obtained and are thus already stored in the archive. Based on and/or in response to reception of the request at arrow 800, messaging system 600 may be configured to retrieve the set of messages, as indicated by block 802. Based on and/or in response to retrieval of the set of messages at block 802, messaging system 600 may be configured to provide the set of messages to remote network management platform 320, as indicated by arrow 804. In some implementations, the set of messages may be unfiltered, and may thus accurately reproduce the one or more conversations that took place on the particular channel.

Messaging system 600 may be configured to delete the set of messages, as indicated by block 806. The set of messages may be deleted at block 806 based on and/or in response to passage of a predetermined amount of time. For example, individual messages may be deleted as the age of each message exceeds a threshold age. In another example, the set of messages may be deleted after the corresponding conversation ends. By obtaining and processing the set of messages prior to deletion thereof from messaging system 600, remote network management platform 320 may preserve information contained in these messages for future use.

Specifically, based on and/or in response to reception of the set of messages at arrow 804, remote network management platform 320 may be configured to provide the set of messages to machine learning system 610, as indicated by arrow 808. The transmission at arrow 808 may include a request to process the set of messages to identify therein one or more queries and, for each of these queries, determine one or more ranked replies. Accordingly, based on and/or in response to reception of the transmission at arrow 808, machine learning system 610 may be configured to detect a query within the set of messages, as indicated by block 810. The operations of block 810 may be performed by query detection model 704, as discussed with respect to FIG. 7.

Based on and/or in response to detection of the query at block 812, machine learning system 610 may be configured to detect one or more replies to the query, as indicated by block 812. The operations of block 812 may be performed by reply detection model 712, as discussed with respect to FIG. 7. Based on and/or in response to detection of the replies at block 812, machine learning system 610 may be configured to rank the replies, as indicated by block 814. The operations of block 814 may be performed by reply ranking model 718, as discussed with respect to FIG. 7. Based on and/or in response to ranking the replies at block 814, machine learning system 610 may be configured to provide the query and the ranked replies to remote network management platform 320, as indicated by arrow 816. The operations of arrow 816 may be performed by reply filter 722, as discussed with respect to FIG. 7.

Based on and/or in response to reception of the query and ranked replies at arrow 816, remote network management platform 320 may be configured to store, in an archive, the query and the ranked replies, as indicated by block 820. Specifically, when stored in the archive, the query may be associated with its corresponding ranked replies, and the archive may thus include an indication that the replies relate to the query. For example, this association may indicate that the replies likely constitute correct answers to the query, at least according to machine learning system 610.

Since the query and replies stored at block 820 are machine-generated, some of the replies may sometimes be incorrect. In one example, a reply may be incorrect due to imperfections, inaccuracies, and/or artifacts present within training data used to train machine learning system 610. In another example, a reply may be incorrect due to a user confidently, but incorrectly, providing an incorrect answer to a query. Accordingly, remote network management platform 320 may be configured to request that a human arbiter review certain queries and replies in order to verify and/or correct the outputs of machine learning system 610.

Turning to FIG. 8B, remote network management platform 320 may be configured to select a human arbiter for the query, as indicated by block 822. For example, queries may be grouped by topics. In one example, the topic of the query may be determined based on the channel on which the query appeared. In another example, the topic of the query may be determined based on the embedding vector of the query belonging to a cluster containing a plurality of queries on a corresponding topic. The human arbiter for a given topic may be manually defined by one or more users associated with remote network management platform 320, or may be dynamically determined by remote network management platform 320 based on, for example, a frequency with which the human arbiter correctly replies to queries of the given topic.

Based on and/or in response to selection of the human arbiter at block 822, remote network management platform 320 may be configured to provide, to arbiter device 860, the query and its ranked replies, as indicated by arrow 824. Arbiter device 860 may be a computing device or other computing resource associated with and/or used by the human arbiter selected at block 822. Accordingly, based on and/or in response to reception of the query and its ranked replies at arrow 824, arbiter device 860 may be configured to display the query and its ranked replies, as indicated by block 826. Based on and/or in response to display of the query and its ranked replies at block 826, arbiter device 860 may be configured to receive, from the human arbiter and by way of a user interface, a canonical reply to the query, as indicated by block 828.

For example, arbiter device 860 may be configured to provide a graphical user interface that includes the query, a checkbox for selecting each of the replies, and a text box allowing for manual entry of a reply other than the machine-generated replies. Thus, the human arbiter may, based on reading the query, select one of the machine-generated replies by checking the corresponding checkbox, or enter into the text box (i) a modified version of one or the machine-generated replies or (ii) a new reply that is not based on any of the machine-generated replies. The reply provided by the human arbiter may be considered to be canonical, or verified, in that it may be accepted as being accurate and/or authoritative due to being provided by the human arbiter (rather than a user that is not classified as an arbiter).

Based on and/or in response to reception of the canonical reply at block 828, arbiter device 860 may be configured to provide the canonical reply to remote network management platform 320, as indicated by arrow 830. Based on and/or in response to reception of the canonical reply at arrow 830, remote network management platform 320 may be configured to store, in the archive, the canonical reply and an indication that the canonical reply is a preferred response to the query, as indicated by block 832.

In one example, the indication that the canonical reply is the preferred reply for the query may be expressed by a revision to the ranking of the replies generated at block 814. For example, the ranking may be adjusted such that the canonical reply becomes the highest-ranked reply, and is thus considered the preferred response. In another example, the indication that the canonical reply is the preferred reply for the query may be expressed by a deletion of the machine-generated replies, and thus keeping the canonical reply as the only reply to the query. In a further example, the indication that the canonical reply is the preferred reply for the query may be expressed by storing the canonical reply in association with an indication that the canonical reply has been provided by the human arbiter.

The operations of FIGS. 8A and 8B may be repeated to identify a plurality of different queries and replies thereto. Once an archive of queries and corresponding replies is generated, the archive may be used to reply to future queries from users associated with remote network management platform 320. Accordingly, turning to FIG. 8C, messaging system 600 may be configured to receive a request to post a second query, as indicated by block 834. The request at block 834 may be received from a user associated with remote network management platform 320 and may be associated with a corresponding channel of the plurality of channels available on messaging system 600.

Based on and/or in response to reception of the request at block 834 and/or posting of the second query to the corresponding channel, messaging system 600 may be configured to provide, to remote network management platform 320, an indication that a channel contains new content, as indicated by arrow 836. The channel indicated at arrow 836 may be the channel to which the second query has been posted at block 834. In some implementations, the indication at arrow 836 may include the new content. In other implementations, the indication at arrow 836 may be a notification, and remote network management platform 320 may be configured to obtain the new content by way of a separate transaction (not shown) with messaging system 600.

Based on and/or in response to reception of the new content (e.g., at arrow 836), remote network management platform 320 may be configured to provide, to machine learning system 610, the new content, as indicated by arrow 838. Based on and/or in response to reception of the new content, machine learning system 610 may be configured to detect the second query within the new content, as indicated by block 840. The operations of block 840 may be performed by query detection model 704, as discussed with respect to FIG. 7. If no query is detected within the new content, machine learning system 610 may provide, to remote network management platform 320, an indication (not shown) that the new content does not contain a query.

Based on and/or in response to detection of the second query at block 840, machine learning model may be configured to generate a reference embedding vector for the second query, as indicated by block 842. The reference embedding vector may be generated in the same manner as embedding vector 726. For example, the reference embedding vector may be generated by the embedding layer of reply detection model 712. Accordingly, the reference embedding vector may be comparable to previously-generated embedding vectors that represent corresponding previously-answered queries in order to identify similar previously-answered queries, thereby identifying possible replies to the second query.

Based on and/or in response to generation of the reference embedding vector at block 842, machine learning system 610 may be configured to provide, to remote network management platform 320, the second query and the reference embedding vector, as indicated by arrow 844. Based on and/or in response to reception of the second query and the reference embedding vector at arrow 844, remote network management platform 320 may be configured to identify and rank candidate queries corresponding to the second query, as indicated by block 846. Specifically, the candidate queries may be identified based on a comparison of the reference embedding vector to the embedding vectors that represent the candidate queries. An extent of similarity between the second query and a given candidate query may be quantified by determining a distance (e.g., Euclidean distance) between (i) the reference embedding vector and (ii) an embedding vector that represents the given candidate query.

Accordingly, in one example, the candidate queries may include a predetermined number of queries that are most similar to the second query. In another example, the candidate queries may include any queries associated with corresponding embedding vectors that are within a threshold distance of the reference embedding vector. In some implementations, the candidate queries may be selected based additionally on each of the candidate queries being associated with a corresponding canonical reply. Thus, embedding vectors of queries for which a canonical reply has not been provided might not be compared to the reference embedding vector. The candidate queries may be ranked according to the extent of similarity, with candidate queries associated with embedding vectors that are closest to the reference embedding vector being ranked highest. The respective replies (e.g., canonical replies) of one or more highest-ranked candidate queries may thus be the most likely correct replies to the second query.

In some implementations, remote network management platform 320 may additionally or alternatively use a different textual similarity metric to identify and rank the candidate queries. For example, remote network management platform 320 may be configured to identify the candidate queries using Jaccard similarity between the second query and the candidate queries. Since the Jaccard similarity may be determined without dependence on embedding vectors, remote network management platform 320 may, in some implementations, be configured to identify the candidate queries without utilizing machine learning system 610 (i.e., the operations of arrow 838, block 840, block 842, and arrow 844 may be omitted).

Based on and/or in response to identifying and ranking the candidate queries at block 846, remote network management platform 320 may be configured to provide, to messaging system 600, a predetermined number (e.g., 1, 2, or 3) of highest-ranked candidate queries and the replies corresponding thereto, as indicated by arrow 848. The replies corresponding to the candidate queries may include, for each respective candidate query, the corresponding canonical reply and/or one or more highest-ranked machine-generated replies for the candidate query. The transmission at arrow 848 may indicate that the candidate queries and replies are being provided in response to the second query that has been posted at block 834.

Based on and/or in response to reception of the candidate queries and replies at arrow 848, messaging system 600 may be configured to post the replies to the highest-ranked candidate queries as a response to the second query, as indicated by block 850. Thus, the second query may automatically be answered by the one or more replies corresponding to the highest-ranked candidate queries. In some cases, at least one of the highest-ranked candidate queries may be the same as or substantially similar to the second query, such that a correct reply to this candidate query is also a correct reply to the second query. Accordingly, information that might otherwise be discarded by messaging system 600 may instead be archived by remote network management platform 320 and used to correctly reply to queries concerning this information.

Such archival of the information and automatic generation of replies to queries may be especially beneficial when the information contained in the messages posted on messaging system 600 is not otherwise formally published and/or stored by remote network management platform 320. For example, when the information is known to a small number of users, but is not stored in a database that is accessible to other users, automatically providing such information in response to user queries may operate to explicitly integrate decentralized information sources into a centralized information archive.

### VIII. EXAMPLE OPERATIONS

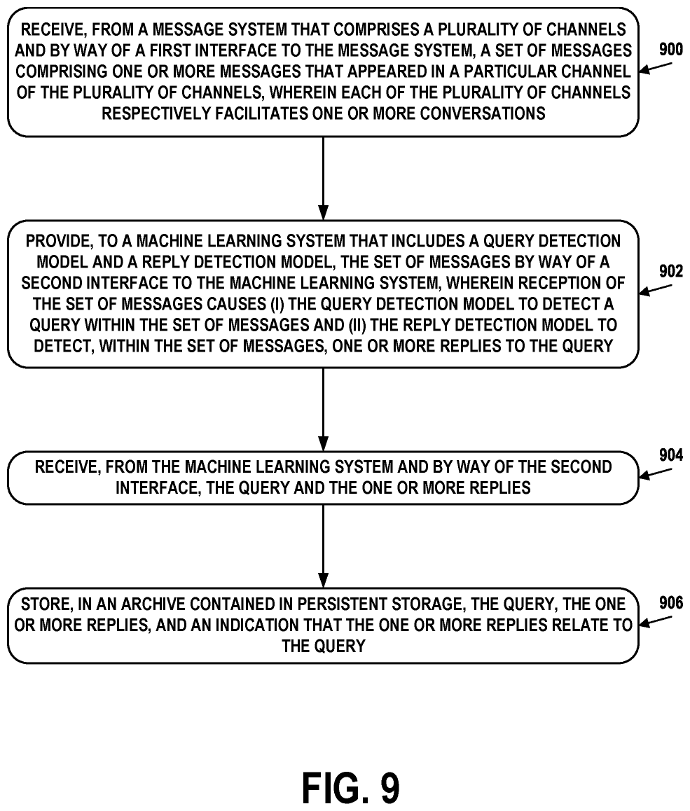

FIG. 9 is a flow chart illustrating an example embodiment. The process illustrated by FIG. 9 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 9 may be simplified by the removal of any one or more of the features shown therein. Further, these embodiments may be combined with features, aspects, and/or implementations of any of the previous figures or otherwise described herein.

Block 900 may involve receiving, from a message system that includes a plurality of channels and by way of a first interface to the message system, a set of messages including one or more messages that appeared in a particular channel of the plurality of channels. Each of the plurality of channels may respectively facilitate one or more conversations.

Block 902 may involve providing, to a machine learning system that includes a query detection model and a reply detection model, the set of messages by way of a second interface to the machine learning system. Reception of the set of messages may cause (i) the query detection model to detect a query within the set of messages and (ii) the reply detection model to detect, within the set of messages, one or more replies to the query.

Block 904 may involve receiving, from the machine learning system and by way of the second interface, the query and the one or more replies.

Block 906 may involve storing, in an archive contained in persistent storage, the query, the one or more replies, and an indication that the one or more replies relate to the query.

In some embodiments, the messaging system may be configured to delete its copy of the set of messages after a predetermined period of time.

In some embodiments, the machine learning system may include a reply ranking model configured to determine a ranking of the one or more replies in order of predicted relevance. Storing the one or more replies may include storing the one or more replies with indications of the ranking thereof.

In some embodiments, each respective reply of the one or more replies may be associated with a corresponding user feedback. The reply ranking model may be configured to determine the ranking based on sentiment analysis of the corresponding user feedback of each respective reply.

In some embodiments, the corresponding user feedback of each respective reply may include one or more of (i) text, (ii) image data, or (iii) pictorial symbol. The reply ranking model may be configured to perform the sentiment analysis based on user feedback expressed as one or more of (i) text, (ii) image data, or (iii) pictorial symbol.

In some embodiments, the reply detection model may be configured to determine, for each respective reply of the one or more replies, a corresponding confidence value associated with the respective reply and indicating a likelihood that the respective reply is a correct response to the query. The reply ranking model may be configured to determine the ranking based on the corresponding confidence value of each respective reply.

In some embodiments, each respective reply of the one or more replies may be associated with a corresponding age value indicating an amount of time since the respective reply has been generated. The reply ranking model may be configured to determine the ranking based on the corresponding age value of each respective reply.

In some embodiments, the query and the one or more replies may be provided, by way of a user interface, to a human arbiter. A representation of a canonical reply to the query may be received by way of the user interface. The canonical reply may be either one of the one or more replies, an edited version of one of the one or more replies, or a reply provided by the human arbiter. The canonical reply and an indication that the canonical reply is a preferred reply for the query may be stored in the archive.

In some embodiments, a corresponding frequency may be determined for each respective user of a plurality of users that provided responses on the particular channel. The corresponding frequency may be a frequency with which the respective user provided correct responses on the particular channel. A particular user of the plurality of users may be selected as the human arbiter for the particular channel based on the corresponding frequency of the particular user exceeding a threshold frequency.

In some embodiments, a second set of messages may be received from the message system. The second set of messages may include one or more second messages that appeared in a second particular channel of the plurality of channels. The second set of messages may be provided to the machine learning system. Reception of the second set of messages may cause (i) the query detection model to detect the query within the second set of messages and (ii) the reply detection model to detect, within the second set of messages, one or more further replies to the query. Detecting the query within the second set of messages may include determining that a textual similarity metric between the query and one of the second set of messages is within a predetermined range. The query and the one or more further replies may be received from the machine learning system. The one or more further replies, and an indication that the one or more further replies relate to the query may be stored in the archive.

In some embodiments, the machine learning system may have been trained using a corpus of text that includes queries and associated replies.

In some embodiments, the reply detection model may include a bidirectional encoder representations from transformers (BERT) model that has been fine-tuned using a corpus of text obtained from the messaging system.

In some embodiments, the operations of FIG. 9 may be carried out by a computational instance of a remote network management platform. The messaging system may operate on a first set of one or more remote servers outside of the remote network management platform. The machine learning system may operate on a second set of one or more remote servers outside of the remote network management platform.

In some embodiments, a second query provided by a human user may be received from the messaging system. A plurality of candidate queries that are similar to the second query may be determined by searching the archive. A ranking of the plurality of candidate queries may be determined based on an extent of similarity between the second query and each respective candidate query of the plurality of candidate queries. A predetermined number of highest-ranked queries corresponding to the second query and the one or more replies related to each of the highest-ranked queries may be provided to the messaging system and based on the ranking.

In some embodiments, each respective candidate query of the plurality of candidate queries may be represented by a corresponding embedding vector generated by the machine learning system based on the respective candidate query. Determining the plurality of candidate queries may include obtaining, from the machine learning system, a reference embedding vector corresponding to the second query and generated by the machine learning system based on the second query, and identifying a plurality of embedding vectors located within a threshold distance of the reference embedding vector. Determining a ranking of the plurality of candidate queries may include, for each respective embedding vector of the plurality of embedding vectors, determining a corresponding distance between the respective embedding vector and the reference embedding vector, and ranking the plurality of embedding vectors according to the corresponding distance determined for each respective embedding vector.

### IX. CLOSING

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A system comprising:
persistent storage containing an archive;
a first interface to a messaging system, wherein the messaging system comprises a plurality of channels, wherein each of the plurality of channels respectively facilitates one or more conversations;
a second interface to a machine learning system, wherein the machine learning system comprises a query detection model and a reply detection model; and
one or more processors configured to perform operations comprising:
receiving, from the message system and by way of the first interface, a set of messages comprising one or more messages that appeared in a particular channel of the plurality of channels;
providing, to the machine learning system and by way of the second interface, the set of messages, wherein reception of the set of messages causes (i) the query detection model to detect a query within the set of messages and (ii) the reply detection model to detect, within the set of messages, one or more replies to the query;
receiving, from the machine learning system and by way of the second interface, the query and the one or more replies; and
storing, in the archive, the query, the one or more replies, and an indication that the one or more replies relate to the query.

2. The system of claim 1, wherein the messaging system is configured to delete its copy of the set of messages after a predetermined period of time.

3. The system of claim 1, wherein the machine learning system comprises a reply ranking model configured to determine a ranking of the one or more replies in order of predicted relevance, and wherein storing the one or more replies comprises storing the one or more replies with indications of the ranking thereof.

4. The system of claim 3, wherein each respective reply of the one or more replies is associated with a corresponding user feedback, and wherein the reply ranking model is configured to determine the ranking based on sentiment analysis of the corresponding user feedback of each respective reply.

5. The system of claim 4, wherein the corresponding user feedback of each respective reply comprises one or more of (i) text, (ii) image data, or (iii) pictorial symbol, and wherein the reply ranking model is configured to perform the sentiment analysis based on user feedback expressed as one or more of (i) text, (ii) image data, or (iii) pictorial symbol.

6. The system of claim 3, wherein the reply detection model is configured to determine, for each respective reply of the one or more replies, a corresponding confidence value associated with the respective reply and indicating a likelihood that the respective reply is a correct response to the query, wherein the reply ranking model is configured to determine the ranking based on the corresponding confidence value of each respective reply.

7. The system of claim 3, wherein each respective reply of the one or more replies is associated with a corresponding age value indicating an amount of time since the respective reply has been generated, and wherein the reply ranking model is configured to determine the ranking based on the corresponding age value of each respective reply.

8. The system of claim 1, wherein the operations further comprise:
providing, by way of a user interface, the query and the one or more replies to a human arbiter;
receiving, by way of the user interface, a representation of a canonical reply to the query, wherein the canonical reply is either one of the one or more replies, an edited version of one of the one or more replies, or a reply provided by the human arbiter; and
storing, in the archive, the canonical reply and an indication that the canonical reply is a preferred reply for the query.

9. The system of claim 8, wherein the operations further comprise:
determining, for each respective user of a plurality of users that provided responses on the particular channel, a corresponding frequency with which the respective user provided correct responses on the particular channel; and
selecting a particular user of the plurality of users as the human arbiter for the particular channel based on the corresponding frequency of the particular user exceeding a threshold frequency.

10. The system of claim 1, wherein the operations further comprise:
receiving, from the message system, a second set of messages comprising one or more second messages that appeared in a second particular channel of the plurality of channels;
providing, to the machine learning system, the second set of messages, wherein reception of the second set of messages causes (i) the query detection model to detect the query within the second set of messages and (ii) the reply detection model to detect, within the second set of messages, one or more further replies to the query, wherein detecting the query within the second set of messages comprises determining that a textual similarity metric between the query and one of the second set of messages is within a predetermined range;
receiving, from the machine learning system, the query and the one or more further replies; and
storing, in the archive, the one or more further replies, and an indication that the one or more further replies relate to the query.

11. The system of claim 1, wherein the machine learning system has been trained using a corpus of text comprising queries and associated replies.

12. The system of claim 1, wherein the reply detection model comprises a bidirectional encoder representations from transformers (BERT) model that has been fine-tuned using a corpus of text obtained from the messaging system.

13. The system of claim 1, wherein the system is a computational instance of a remote network management platform, wherein the messaging system operates on a first set of one or more remote servers outside of the remote network management platform, and wherein the machine learning system operates on a second set of one or more remote servers outside of the remote network management platform.

14. The system of claim 1, wherein the operations further comprise:
receiving, from the messaging system, a second query provided by a human user;
determining, by searching the archive, a plurality of candidate queries that are similar to the second query;
determining a ranking of the plurality of candidate queries based on an extent of similarity between the second query and each respective candidate query of the plurality of candidate queries; and
providing, to the messaging system and based on the ranking, a predetermined number of highest-ranked queries corresponding to the second query and the one or more replies related to each of the highest-ranked queries.

15. The system of claim 14, wherein:
each respective candidate query of the plurality of candidate queries is represented by a corresponding embedding vector generated by the machine learning system based on the respective candidate query;
determining the plurality of candidate queries comprises:
obtaining, from the machine learning system, a reference embedding vector corresponding to the second query and generated by the machine learning system based on the second query; and
identifying a plurality of embedding vectors located within a threshold distance of the reference embedding vector;
determining a ranking of the plurality of candidate queries comprises:
for each respective embedding vector of the plurality of embedding vectors, determining a corresponding distance between the respective embedding vector and the reference embedding vector; and
ranking the plurality of embedding vectors according to the corresponding distance determined for each respective embedding vector.

16. A computer-implemented method comprising:
receiving, from a message system that comprises a plurality of channels and by way of a first interface to the message system, a set of messages comprising one or more messages that appeared in a particular channel of the plurality of channels, wherein each of the plurality of channels respectively facilitates one or more conversations;
providing, to a machine learning system that includes a query detection model and a reply detection model, the set of messages by way of a second interface to the machine learning system, wherein reception of the set of messages causes (i) the query detection model to detect a query within the set of messages and (ii) the reply detection model to detect, within the set of messages, one or more replies to the query;
receiving, from the machine learning system and by way of the second interface, the query and the one or more replies; and
storing, in an archive contained in persistent storage, the query, the one or more replies, and an indication that the one or more replies relate to the query.

17. The computer-implemented method of claim 16, wherein the machine learning system comprises a reply ranking model configured to determine a ranking of the one or more replies in order of predicted relevance, and wherein storing the one or more replies comprises storing the one or more replies with indications of the ranking thereof.

18. The computer-implemented method of claim 17, wherein each respective reply of the one or more replies is associated with a corresponding user feedback, and wherein the reply ranking model is configured to determine the ranking based on sentiment analysis of the corresponding user feedback of each respective reply.

19. The computer-implemented method of claim 17, wherein the reply detection model is configured to determine, for each respective reply of the one or more replies, a corresponding confidence value associated with the respective reply and indicating a likelihood that the respective reply is a correct response to the query, wherein the reply ranking model is configured to determine the ranking based on the corresponding confidence value of each respective reply.

20. An article of manufacture including a non-transitory computer-readable medium, having stored thereon program instructions that, upon execution by a computing system, cause the computing system to perform operations comprising:
receiving, from a message system that comprises a plurality of channels and by way of a first interface to the message system, a set of messages comprising one or more messages that appeared in a particular channel of the plurality of channels, wherein each of the plurality of channels respectively facilitates one or more conversations;
providing, to a machine learning system that includes a query detection model and a reply detection model, the set of messages by way of a second interface to the machine learning system, wherein reception of the set of messages causes (i) the query detection model to detect a query within the set of messages and (ii) the reply detection model to detect, within the set of messages, one or more replies to the query;
receiving, from the machine learning system and by way of the second interface, the query and the one or more replies; and
storing, in an archive contained in persistent storage, the query, the one or more replies, and an indication that the one or more replies relate to the query.
